(19) United States
(12) Patent Application Publication
(10) Pub. No.: US 2026/0299948 A1
(43) Pub. Date: Oct. 1, 2026

(54) DESCRIPTOR-BASED HARDWARE PREFETCHER

(71) Applicant: ADVANCED MICRO DEVICES, INC., Santa Clara, CA (US)

(72) Inventors: Onur Kayiran, West Henrietta, NY (US); Gabriel H. Loh, Bellevue, WA (US); Rishabh Jain, State College, PA (US); Masab Ahmad, Austin, TX (US)

(21) Appl. No.: 19/093,937

(22) Filed: Mar. 28, 2025

(51) Int. Cl. G06F 9/30

(52) U.S. Cl. CPC G06F 9/30047; G06F 9/30065

(57) ABSTRACT

A processor prefetches data based on access-pattern descriptors that delineate the expected storage patterns for data stored at a memory. An executing program, such as a machine learning model, generates the access-pattern descriptors to indicate the expected storage patterns. A hardware prefetcher of the processor employs the access-pattern descriptors to generate prefetch requests for the data, and cache of the processor executes the prefetch requests to transfer data to the cache for subsequent retrieval and use by the executing program. By employing the hardware prefetcher to generate the prefetch requests based on the access-pattern descriptors, the processing system reduces memory latency associated with more complex data structures, thereby improving overall processing efficiency

### BACKGROUND

To improve processing efficiency, some processors employ prefetching, wherein data that is expected to be accessed in the near future is retrieved from relatively slow memory (e.g., system memory or a higher-level cache) to relatively fast memory (e.g., a lower-level cache), before that data is explicitly requested for use by an executing program. Typically, prefetching is performed by hardware or software analyzing memory requests over time, identifying access patterns based on the memory access requests, and the processor prefetching data to a cache based on the identified access patterns. For example, some processors employ one or more stride prefetchers that identify patterns in the differences, or strides, between sequences of memory addresses in a set of memory access requests, and prefetching data based upon the identified strides. However, conventional hardware prefetchers typically identify relatively simple memory access patterns and exhibit relatively poor performance for programs that employ more complex data structures. For example, machine learning models (MLMs) often employ complex data structures such as tensors having a high number of dimensions, and dimensions that change during program execution. For such complex data structures, conventional prefetching techniques have difficulty identifying useful access patterns and can negatively impact processing performance by polluting processor caches with unwanted data.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including a hardware prefetcher that employs access-pattern descriptors to generate prefetch requests in accordance with some implementations.

FIG. 2 is a block diagram illustrating a two-dimensional access pattern for data at the processing system of FIG. 1 in accordance with some implementations.

FIG. 3 is a block diagram illustrating an example descriptor for the hardware prefetcher of FIG. 1 in accordance with some implementations.

FIGS. 4 and 5 are block diagrams illustrating additional examples of descriptors for the hardware prefetcher of FIG. 1 in accordance with some implementations.

FIG. 6 is a block diagram illustrating an example of an instruction indicating the location of a prefetch descriptor at the processing system of FIG. 1 in accordance with some implementations.

FIG. 7 is a flow diagram illustrating a method for generating prefetch requests at a hardware prefetcher based on access-pattern descriptors in accordance with some implementations.

### DETAILED DESCRIPTION

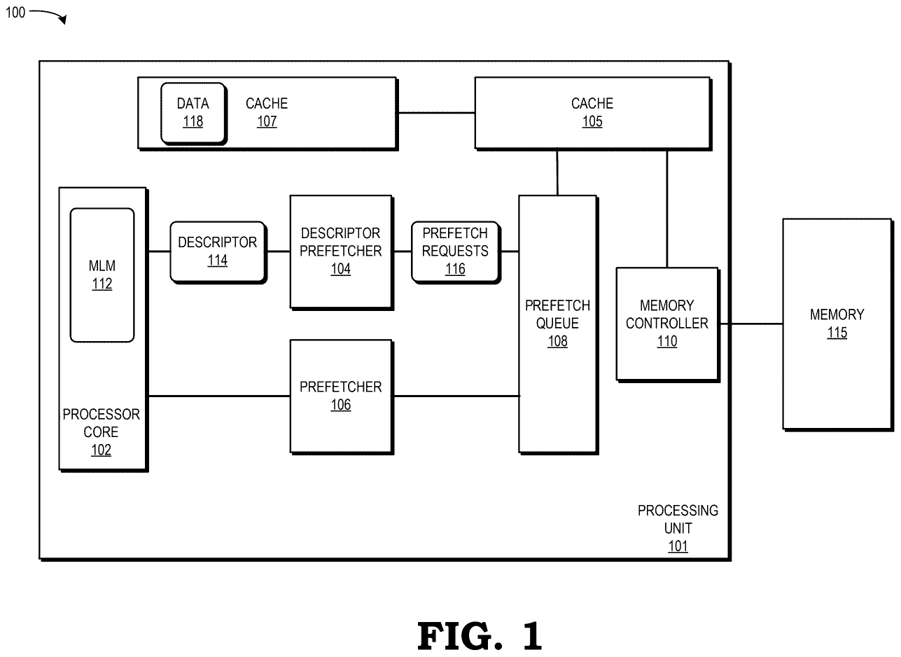

FIGS. 1-7 illustrate techniques for prefetching data at a processor based on descriptors, referred to as access-pattern descriptors, that delineate the expected storage patterns for data stored at a memory. An executing program, such as a machine learning model, generates the access-pattern descriptors to indicate the expected storage patterns. A hardware prefetcher of the processor employs the access-pattern descriptors to generate prefetch requests for the data, and a cache of the processor executes the prefetch requests to transfer data to the cache for subsequent retrieval and use by the executing program. By employing the hardware prefetcher to generate the prefetch requests based on the access-pattern descriptors, the processing system reduces memory latency associated with more complex data structures, thereby improving overall processing efficiency.

To illustrate, some programs employ relatively complex data structures that are stored in system memory of a processing system in a more complex pattern than simple data structures. For example, machine learning models (MLMs) often employ tensor data structures having a high number (e.g., 2, 3, 4, or greater) of dimensions. The tensor data is typically stored at system memory in such a way that the memory addresses associated with the tensor data follow a regular pattern, with the pattern having a number of dimensions that depend, at least in part, on the number of dimensions of the tensor. Furthermore, in some cases the dimensions of the tensor, and the corresponding storage patterns, change over time. Conventional prefetchers, such as stride prefetchers, stream prefetchers, and region prefetchers, typically employ unsupervised learning techniques to identify memory access patterns, and these conventional approaches are unable to accurately identify these more complex memory patterns, leading to cache pollution (that is, storing data at the cache that is not needed by the executing program in the near future), poor prefetch coverage (that is, prefetching only a small portion of the tensor data), and relatively high memory latency. Some processing systems address these issues by employing software prefetching, wherein the executing program issues prefetch instructions to stream data into a register of the processing system. However, this approach substantially increases programming time and overhead, by requiring a programmer to issue separate instructions for each prefetch.

Using the techniques described herein, a hardware prefetcher employs access-pattern descriptors (sometimes referred to herein as “descriptors” for simplicity) issued by an executing program, wherein each descriptor indicates a storage pattern of data at a processing system. Based on a given descriptor, the hardware prefetcher generates a set of prefetch requests, and the prefetch requests are executed by a memory controller to transfer the data to a cache for subsequent access by the executing program. The descriptors identify relatively complex storage patterns for the data, such as N-dimensional storage patterns. For example, in some implementations, a descriptor indicates a base address, representing the first address in the storage pattern, and for each dimension indicates a loop size (indicating, for the corresponding dimension, the number of iterations in the storage pattern) and a stride length (indicating, for the corresponding dimension, the distance (in memory address values) between cache lines to be prefetched. The hardware prefetcher employs the descriptor to generate prefetch requests to prefetch the data according to the storage pattern indicated by the descriptor. Thus, the processing system is able to prefetch data, such as tensor data, that is stored according to a relatively complex storage pattern, thereby reducing prefetch time (that is, the time needed by the processing system to start prefetching), increasing prefetch accuracy and thus reducing cache pollution, and increasing prefetch coverage.

FIG. 1 illustrates a processing system 100 generally configured to execute sets of instructions (e.g., programs) in order to carry out operations, as specified by the sets of instructions, on behalf of an electronic device. Accordingly, in different implementations, the processing system 100 is part of or incorporated in any one of a number of electronic devices, including a desktop computer, laptop computer, server, smartphone, tablet, game console, automobile or other transportation device, and the like. To support execution of instructions, the processing system 100 includes a processing unit 101 and a memory 115. It will be appreciated that the illustrated processing system 100 is an example only, and that in other implementations the techniques described herein are implemented in processing systems having a different configuration, including processing systems having additional processing units, additional memory, and additional circuitry (e.g., network interfaces, sensors, input/output devices and controllers, display devices, audio devices) not explicitly illustrated at FIG. 1.

To support execution of instructions or commands, the processing unit 101 includes one or more processor cores, such as a processor core 102. Each of the processor cores includes one or more instruction pipelines including circuitry to fetch a set of instructions, decode the instructions into corresponding sets of operations, execute the sets of operations at one or more execution units, and retire the operations. The sets of instructions executed by the processor cores form one or more computer programs. For purposes of description, it is assumed that the processing unit 101 includes a processor core 102 that executes and MLM 112. However, it will be appreciated that in other implementations the processing unit 101 includes additional processor cores. In addition, with other implementations the processing unit 101 executes programs other than or in addition to the MLM 112.

The processing unit 101 is generally configured to execute sets of instructions to carry out one or more specified operations indicated by the sets of instructions. For purposes of description, it is assumed that the processing unit 101 is a central processing unit (CPU) configured to execute general instructions, but it will be appreciated that in other implementations, the processing unit 101 is a processing unit including circuits and configured to execute specified commands to execute operations associated with a particular category of operations, such as graphics operations, digital signal processing operations, vector operations, neural network and machine learning operations, and the like or any combination thereof. Thus, in different implementations, the processing unit 101 is a graphics processing unit, neural processing unit, accelerated processing unit, parallel processing unit, vector processing unit, and the like.

In the course of executing instructions, the processing unit 101 generates memory access requests (e.g., write and read requests) to store and retrieve data from a memory hierarchy of the processing system 100. The memory hierarchy includes the memory 115 and one or more caches (e.g., cache 105, cache 107). The memory hierarchy is arranged into different levels, with the different levels of the memory hierarchy having different access latency for the processor core 102. For example, in some implementations the memory 115 is random access memory (RAM) that is external to the processing unit 101, and has a relatively high access latency (that is, the memory 115 requires a relatively large amount of time to access by the processor core 102), but stores a relatively large amount of data. The memory 115 is therefore placed at relatively high level of the memory hierarchy. The caches 105 and 107, in contrast, have a relatively low access latency, and are therefore lower in the memory hierarchy than the memory 115. To illustrate, in some implementations the cache 105 is a level 2 (L2) cache that a relatively small amount of time, as compared to the memory 115, to access by the processor core 102, but stores a smaller amount of data, and is lower in the memory hierarchy than the memory 115. The cache 105 is a level 1 (L1) cache at the lowest level in the memory hierarchy, and stores a smaller amount of data than the cache 107, but it requires a smaller amount of time (relative to the cache 107) to access than the cache 107.

It will be appreciated that in some implementations, the processing system 101 includes additional memory, representing additional levels in the memory hierarchy. For example, in some implementations, the cache 105 is a level 1 (L1) cache at the lowest level in the memory hierarchy and the memory 115 is system memory at the highest level of the memory hierarchy, the cache 107 is an L2 cache located above the cache 105 in the memory hierarchy, and the processing unit 101 includes a level 3 (L3) cache (not shown) that are located between the cache 105 and the memory 115 in the memory hierarchy. In addition, in some implementations one or more of the caches and the memory 115 are shared between different processor cores of the processing unit 101.

To reduce overall memory access latency and improve processing efficiency, in some implementations the processing unit 101 implements a specified memory management scheme and moves data among the different levels of the memory hierarchy according to the memory management scheme. For example, in some implementations, based on the memory management scheme, the processing unit 101 moves data that has recently been accessed, or is expected to be accessed, lower in the memory hierarchy, and moves data that has been accessed less recently, or is not expected to be accessed, higher in the memory hierarchy. To support the memory management scheme, the processing unit 101 implements a virtual address space, wherein programs executing at the processing unit 101 access data according to assigned virtual addresses, and the processing unit 101 translates the virtual addresses to physical addresses corresponding to the memory locations where the accessed data is stored (or is to be stored). This allows the processing unit 101 to place data at different physical locations while maintaining the same virtual address, thus allowing the executing programs to access data without regard to the data's physical location.

As noted above, to access data at the memory hierarchy, the processing unit 101 generates memory access requests, wherein each memory access request includes a virtual address indicating the data targeted by the request, and access information indicating the type of memory access request. In some implementations, the memory access requests fall into one of at least two categories: demand requests and prefetch requests. Demand requests are memory access requests, such as read requests and write requests, that are generated by a program executing at the processor core 102 as an explicit demand to load data (for a read request) from the memory hierarchy or store data (for a write request) to the memory hierarchy. Prefetch requests are memory access requests to move data to a different level of the memory hierarchy (e.g., from the cache 107 to the cache 105) without an explicit demand request for the data by the executing program, and based on a prediction that the data is likely to be accessed by the executing program in the near future.

To support execution of memory access requests (both demand and prefetch requests), the processing unit 101 includes a memory controller 110. The memory controller 110 is circuitry configured to receive memory access requests, and to generate control signaling to execute the memory access request at the memory 115 and the cache 105. In some implementations, the memory controller 110 is configured to perform additional operations such as buffering or queueing of memory access requests, management of address translation structures (such as one or more translation lookaside buffers), and the like. It will be appreciated that although the memory controller 110 is illustrated at the processing unit 101 as a single controller, in some implementations the operations of the memory controller 110 described herein are executed by different circuitry, such as one or more additional memory controllers, one or more cache controllers, and the like, or any combination thereof.

To support generation of prefetch requests, the processing unit 101 includes a descriptor prefetcher 104, a prefetcher 106, and a prefetch queue 108. Each of the descriptor prefetcher 104 and prefetcher 106 are circuits configured to generate prefetch requests as described further below, wherein each prefetch request indicates a virtual address of data to be prefetched from the memory 115 to the cache 105. The descriptor prefetcher 104 and prefetcher 106 store the generated prefetch requests at the prefetch queue 108 and the cache 105 is configured to retrieve the prefetch requests from the prefetch queue 108 and execute each request. For example, in some implementations the cache 105 periodically retrieves the top prefetch request stored at the prefetch queue 108, sends control signaling to, for example, the cache 107 to retrieve the data at the physical address, and stores the retrieved data at a cache line of the cache 105 assigned to the virtual address. In some implementations, the cache 107 transfers data to the cache 105 at a specified granularity, such as transferring data at the granularity of a cache line of the cache 105.

The prefetcher 106 is a circuit configured to analyze memory access requests (e.g., demand requests) received by the cache 105, identify patterns in the virtual addresses of the memory access requests, and generate prefetch requests based on the identified patterns. For example, in some implementations the prefetcher 106 is a stride prefetcher that identifies strides patterns in the virtual addresses of the memory access requests, wherein a stride refers to a difference between virtual addresses in a sequence of memory access requests. Based on the stride patterns the prefetcher 106 generates prefetch requests that follow the identified stride patterns. In other implementations the prefetcher 106 is a region prefetcher, a stream prefetcher, or other type of prefetch circuit. In some implementations, the processing unit 101 includes additional prefetchers not illustrated at FIG. 1.

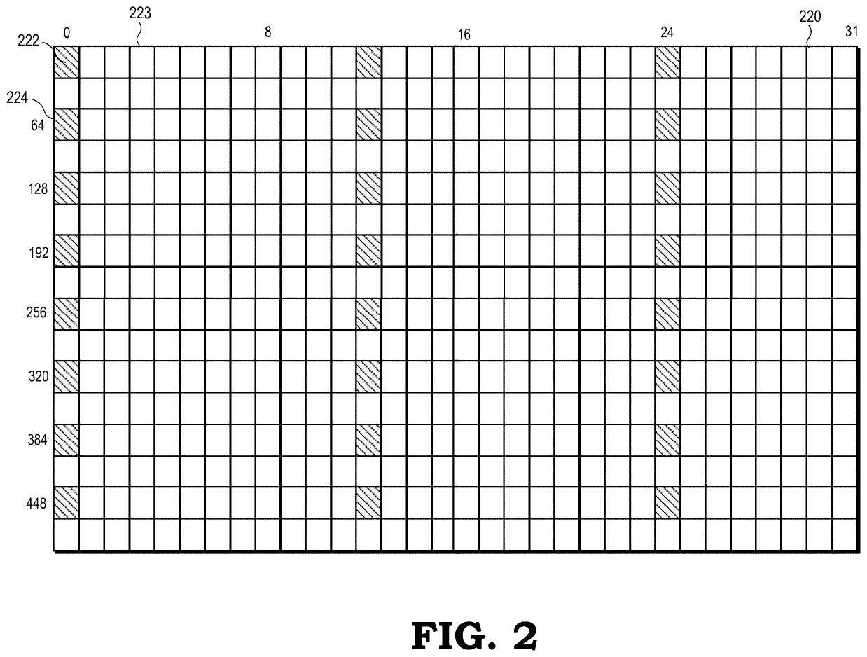

For some types of data, it is difficult for the prefetcher 106 to generate effective and accurate prefetch requests based on analysis of the memory access requests. For example, in some cases the processor core 102 executes an MLM 112 that employs multidimensional tensors stored at the cache 107 as data 118. In some cases, the virtual addresses assigned to the multidimensional tensors by the processing unit 101 have patterns in multiple dimensions. An example is illustrated at FIG. 2 in accordance with some implementations. In particular, FIG. 2 illustrates a set 220 of virtual addresses, wherein each entry (rectangle) in the set corresponds to a different virtual address. Thus, for example, entry 222 corresponds to a given virtual address A, and the entry 223 corresponds to a different virtual address B, with a stride of 3 between virtual address A and virtual address B. It will be appreciated that the two-dimensional layout of the virtual addresses is an example implementation only, and that in other implementations the virtual addresses are arranged in N dimensions, where N is an integer greater than two.

Furthermore, entries with a crosshatch fill represent virtual addresses associated with elements of the same data structure, such as a tensor, a matrix, and the like. In the depicted example, the data structure has a two-dimensional pattern, such that the virtual addresses of entries along a first dimension (the X, or horizontal, dimension of FIG. 1) have a stride value of 12, and along a second dimension (the Y, or vertical dimension) of FIG. 1, have a stride value of 64. In addition, the pattern includes three entries along the X dimension and eight entries along the Y dimension. Accordingly, the elements of the data structure are able to be accessed efficiently according to a two-dimensional access pattern, starting with a base address (entry 222), proceeding with a stride value of 12 for two iterations, then adding 64 to the base address (the address corresponding to entry 222) to proceed to entry 224, proceeding with a stride value of 12 for two iterations, and so on until eight iterations along the Y axis have been completed. In other words, the access pattern of the data structure is represented by two loops, an “inner” loop of the X axis, with three iterations of the loop and a stride length of 12, and an “outer” loop of the Y axis, with eight iterations of the loop and a stride value of 64.

In some cases, the prefetcher 106 (that is, a stride prefetcher, region prefetcher, or other prefetcher that identifies memory address patterns based on analyzing memory accesses) has difficulty identifying multidimensional address patterns, and in particular memory address patterns having three or more dimensions such as the two-dimensional access pattern illustrated at FIG. 2. To enhance prefetching accuracy and efficiency for data structures associated with multi-dimensional access patterns, the processing unit 101 includes the descriptor prefetcher 104. The descriptor prefetcher 104 is one or more circuits that together are configured to receive access pattern descriptors (e.g., descriptor 114) from the processor core 102, wherein each descriptor identifies a multi-dimensional memory access pattern. The descriptor prefetcher 104 is configured to generate prefetch requests (e.g., prefetch requests 116) based on each received descriptor to prefetch data to the cache 105 according to the access pattern indicated by the descriptor.

For example, in some implementations the descriptor 114 indicates a base address indicating the first address of a data structure to be prefetched, and further indicates, for each dimension of a plurality of dimensions a stride length for the dimension and a loop size for the dimension, wherein the loop size indicates the number of iterations of the pattern for the corresponding dimension. Thus, for the example memory access pattern described above with respect to FIG. 2, the descriptor 114 indicates the base address for entry 222, a stride length of 12 for the X axis, a stride length of 64 for the Y axis, a loop size of three for the X axis, and a loop size of eight for the Y axis. The descriptor prefetcher 104 includes one or more adders and other circuits to calculate the virtual addresses for each element of the data structure, according to the pattern set forth by the descriptor 114. The descriptor prefetcher 104 generates a prefetch request for each virtual address and stores the resulting prefetch requests 116 at the prefetch queue 108. The cache 105 subsequently executes the prefetch requests stored at the prefetch queue 108, as described above, thus transferring the elements of the data structure from the cache 107 to the cache 105. Thus, the descriptor prefetcher 104 supports prefetching for data structures having relatively complex memory storage patterns and thus reduces overall memory latency at the processing unit 101.

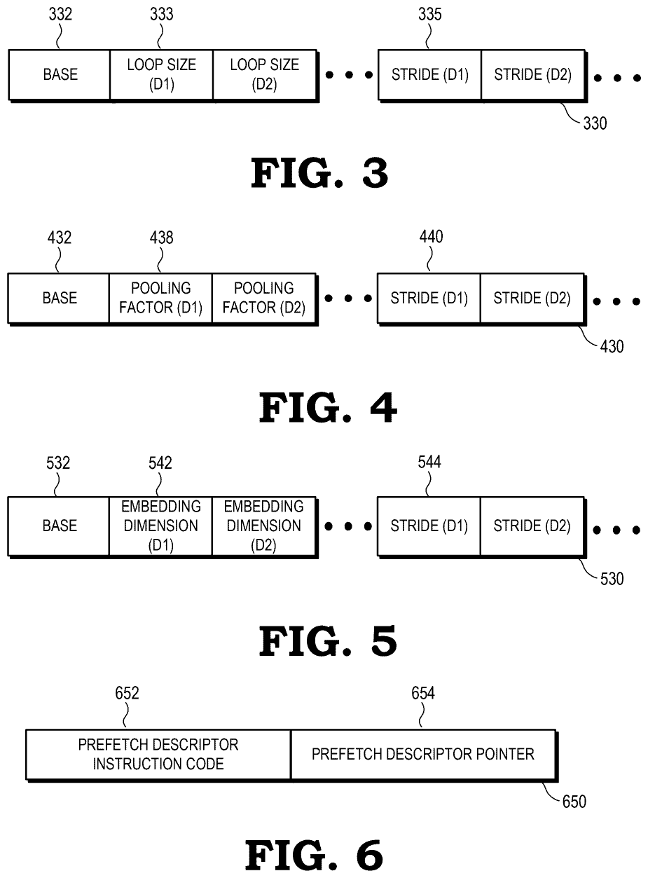

FIG. 3 illustrates an example access pattern descriptor 330 employed by the descriptor prefetcher 104 in accordance with some implementations. The descriptor 330 includes a plurality of fields, including a base address field 332, a plurality of loop size fields (e.g., loop size field 333), and a plurality of stride fields (e.g., stride field 335). The base address field 332 identifies the initial virtual address to be prefetched. Each loop size field indicates, for a corresponding dimension, the number of prefetch iterations for that dimension. Each stride field indicates, for a corresponding dimension, the strid length for that dimension.

The descriptor prefetcher 104 employs the access pattern descriptor 330 to generate a plurality of prefetch requests. In particular, in some implementations the descriptor prefetcher 104 executes a set of nested loops, with each loop corresponding to a different dimension and having a number of iterations corresponding to the respective loop size field of the access pattern descriptor. For each loop, the descriptor prefetcher 104 adds the corresponding stride length, as indicated by the respective stride length field, to a stored address value for the loop and then executes the corresponding subset of loops. For the base or lowest loop, the descriptor prefetcher 104 adds the stride length to a corresponding stored address value (initialized with the base address) and generates a prefetch request targeting the resulting memory address. The descriptor prefetcher thereby generates a plurality of prefetch requests that follow an access pattern defined by the descriptor 330. In some implementations, the descriptor 330 is issued by the MLM 112 for a specified type of data structure, such as an offset array.

In some implementations, the descriptor issued by the MLM 112 indicates an MLM characteristic, and the descriptor prefetcher 104 employs the MLM characteristic to identify a loop size, a stride length, or other pattern characteristic. An example is illustrated at FIG. 4 in accordance with some implementations. In particular, FIG. 4 illustrates an example access pattern descriptor 430, including a base address field 432, a plurality of pooling factor fields (e.g., pooling factor field 438), and a plurality of stride fields (e.g., stride field 440). Similar to the descriptor 330 of FIG. 3, the base address field 432 identifies the initial virtual address to be prefetched, and each stride field indicates, for a corresponding dimension, the stride length for that dimension.

Each of the pooling factor fields indicates, for a corresponding dimension, a pooling factor for the MLM 112. The descriptor prefetcher 104 employs the pooling factor for each dimension to determine, according to a specified formula, a loop size for that dimension. For example, in some implementations, the descriptor prefetcher 104 employs the following formula to determine the loop size for a dimension:

$$loop size = \frac{pooling factor * 4 bytes}{CLS}$$

where CLS is the cache line size for the cache 105. The descriptor prefetcher 104 employs the determined loop sizes, along with the stride lengths and base address, to generate prefetch requests in a similar fashion as described above with respect to FIG. 3. In some implementations, the descriptor 430 is issued by the MLM 112 for a specified type of data structure, such as an index array.

FIG. 5 illustrates another example of an access pattern descriptor in accordance with some implementations. In particular, FIG. 5 illustrates an example descriptor 530, including a base address field 532, a plurality of embedding dimension fields (e.g., embedding dimension field 542), and a plurality of stride fields (e.g., stride field 544). Similar to the descriptor 330 of FIG. 3, the base address field 532 identifies the initial virtual address to be prefetched, and each stride field indicates, for a corresponding dimension, the stride length for that dimension.

Each of the embedding dimension fields indicates, for a corresponding dimension, an embedding factor for the MLM 112. Similar to the pooling factor fields of the descriptor 430 (FIG. 4), the descriptor prefetcher 104 employs the embedding dimension for each dimension to determine, according to a specified formula, a loop size for that dimension. For example, in some implementations, the descriptor prefetcher 104 employs the following formula to determine the loop size for a dimension:

$$loop size = \frac{embedding dimension * 4 bytes}{CLS}$$

where CLS is the cache line size for the cache 105. The descriptor prefetcher 104 employs the determined loop sizes, along with the stride lengths and base address, to generate prefetch requests in a similar fashion as described above with respect to FIG. 3. In some implementations, the descriptor 530 is issued by the MLM 112 for a specified type of data structure, such as a row vector array.

It will be appreciated that the descriptors 330, 430, and 530 are examples only, and in some implementations the descriptor 114 includes additional information, or different information, from these examples. For example, in some implementations, the descriptor 114 indicates a final address to be accessed for the corresponding memory access pattern. The descriptor prefetcher 104 is configured to stop generating prefetch requests, for the corresponding descriptor, in response to generating a prefetch request for the indicated address. In some implementations, the final address is indicated in the descriptor 114 by a characteristic of the MLM 112, such as a pooling factor, an embedding dimension, or other characteristic.

In addition, it will be appreciated that, in various implementations, the descriptor 114 identifies an access pattern up to N dimensions, where N is an integer. Thus, in different implementations, the descriptor 114 identifies loop sizes and stride lengths for two, three, four, five, six, or up to N dimensions. Furthermore, in some implementations, one or more of the stride length, loop size, or other field of the descriptor 114 for a given dimension depends upon the stride length, loop size, or other field for a different dimension. The descriptor 114 indicates, for each stride length, loop size, or other field, the computation to be performed for that field, and the descriptor prefetcher 104 determines the value of the field by executing the computation indicated by the descriptor 114.

For example, in some implementations, the descriptor 114 is issued by the MLM 112 for a convolution employing a 6-dimensional tensor A and a 5-dimensional tensor B resulting in a 4-dimensional tensor C. The descriptor 114 is as follows:

$$base = \{ A , B , C \} , size = \{ N , K , H , W , C , Y , X \} , strides = \{ \{ C * H * W , 0 , W , 1 , W * H , W , 1 \} , \{ 0 , X * Y * C , 0 , 0 , X * Y , X , 1 \} , \{ K * W * H , W * H , W , 1 , 0 , 0 , 0 \} \} ]$$

Based on this descriptor 114, the descriptor prefetcher 104 generates prefetch requests that match the access pattern for the following loops:

$$For n to N :$$

$$For k to K :$$

$$For h to H :$$

$$For w to W :$$

$$sum = 0$$

$$For c to C :$$

$$For y to Y :$$

$$For x to X :$$

$$sum += A [ a\_ix ] * B [ b\_ix ]$$

$$C [ c\_ix ] = sum$$

$$Where :$$

$$a\_ix = x + y * W + c * W * H + w + h * W + n * C * H * W$$

$$b\_ix = x + y * X + c * X * Y + k * X * Y * C$$

$$c\_ix = w + h * W + k * W * H + n * K * W * H$$

For some types of data structures and corresponding memory accesses, the start address for the data structure is indirect (e.g., is indicated by a pointer). In some implementations, for such data structures, the descriptor 114 indicates a “no prefetch” hint. In response, the descriptor prefetcher 104 throttles activity, and does not generate prefetch requests.

In some implementations, the descriptor 114 is stored at the memory 115, and the processor core 102 initiates prefetching by issuing an instruction with a pointer to the descriptor 114. An example is illustrated at FIG. 6 in accordance with some implementations. In particular, FIG. 6 illustrates an instruction 650 including an instruction code field 652 and a pointer field 654. The instruction code field 652 includes a code indicating the type of instruction, and that is interpreted by the processor core 102 to identify the instruction 650 as a prefetch instruction. The pointer field 654 stores a pointer value indicating the location of the descriptor 114 at the memory 115.

The instruction 650 is placed by a programmer into a program (e.g., the MLM 112) to be executed by the processor core 102. When the instruction 650 is executed, the processor core 102 reads the descriptor 114 from the memory 115 (using the pointer field 654 to identify the address) and forwards the descriptor 114 to the descriptor prefetcher 104. In some implementations, the instruction 650 specifies additional information, such as the size of the memory region where the descriptor 114 is stored.

In some implementations, the descriptor prefetcher 104 paces the rate of issuing the prefetch requests based on the observed behavior of the processor core 102. For example, in some implementations for each (or a sampled subset) prefetch request issued, the descriptor prefetcher 104 monitors memory access requests to the memory hierarchy, and identifies matching demand requests (that is, the demand requests that subsequently target the prefetched data at the cache 105). The descriptor prefetcher 104 thereby measures the timeliness of the prefetches. If prefetches are returning from the memory hierarchy too soon (or too late) with respect to the timing of the corresponding demand requests, in response the descriptor prefetcher 104 issues the prefetch requests 116 less aggressively (that is, less rapidly) or more aggressively to more closely match the timing of the demand requests. For example, in some implementations the descriptor prefetcher 104 increases the rate of issuing the prefetch requests by skipping one or more iterations of one or more loops for one or more corresponding dimensions.

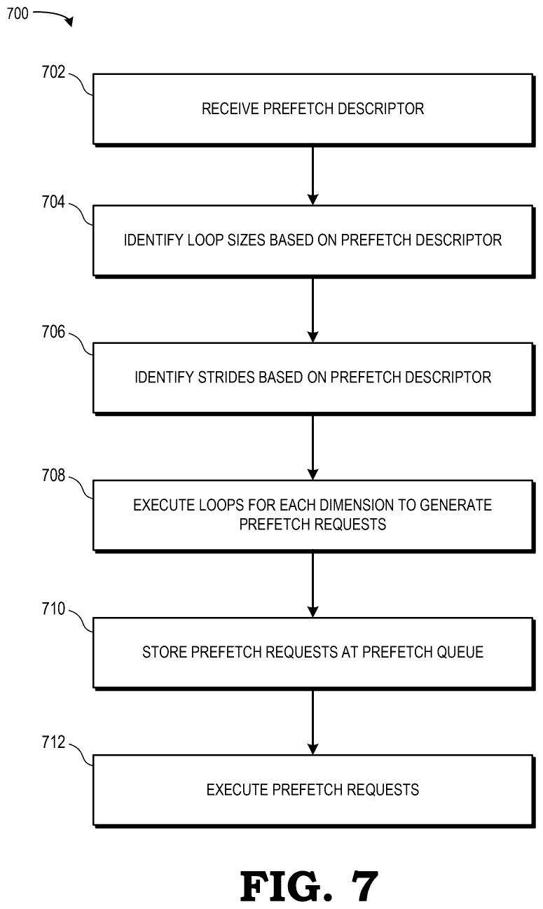

FIG. 7 illustrates a flow diagram of a method 700 of generating and executing prefetch requests in accordance with some implementations. For purposes of description, the method 700 is described with respect to an example implementation at the processing system 100 of FIG. 1, but it will be appreciated that in other implementations the method 700 is implemented at a processor or processing system having a different configuration.

At block 702, the processor core 102 issues the access pattern descriptor 114, which is received by the descriptor prefetcher 104. In some implementations, the descriptor 114 is inserted into a program, such as the MLM 112, by a programmer, to describe a storage pattern for a corresponding data structure, such as an offset array, index array, row vector array, or other data structure. In some implementations, the descriptor 114 indicates, for each of a plurality of pattern dimensions, a corresponding loop size indicating a number of loops associated with the respective dimension, and a stride length for the dimension. Furthermore, in some implementations the descriptor 114 indicates a base address for an initial prefetch request to be generated.

At block 704 the descriptor prefetcher 104 identifies, based on the descriptor 114, a loop size for each of N dimensions of the access pattern, where N is an integer. At block 706 the descriptor prefetcher 104 employs the descriptor 114 to determine a stride for each of the N dimensions of the access pattern. At block 708 the descriptor prefetcher 104 generates the prefetch requests 116 by executing a series of nested loops, each loop corresponding to a different one of the N dimensions of the access pattern and having the corresponding number of iterations identified at block 704. During the loop iterations, the descriptor prefetcher 104 determines the virtual addresses for the prefetch requests 116 using the strides determined at block 706.

At block 710 the processing unit 101 stores the prefetch requests 116 at the prefetch queue 108. At block 712 the cache 105 accesses the stored prefetch requests at the prefetch queue 108 and executes the prefetch requests. Thus, the cache 105 accesses data at the cache 107 based on the access pattern defined the descriptor 114. The processing unit 101 thereby prefetches data stored according to relatively complex storage patterns, thus reducing memory latency and improving processing efficiency at the processing system 100.

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method comprising:
generating, at a hardware prefetcher of a processing unit, a plurality of prefetch requests based on a descriptor indicating a memory access pattern; and
prefetching data to a cache based on the plurality of prefetch requests.

2. The method of claim 1, wherein the descriptor indicates a plurality of loop sizes for N different dimensions of memory access, where N is an integer greater than one.

3. The method of claim 1, wherein the descriptor indicates a plurality of stride lengths for N different dimensions of memory access, where N is an integer greater than one.

4. The method of claim 1, wherein the descriptor indicates a last address to be prefetched to the cache for the memory access pattern.

5. The method of claim 1, wherein the descriptor indicates a pooling factor for a machine learning model to be executed at the processing unit.

6. The method of claim 1, wherein the descriptor indicates an embedding dimension for a machine learning model to be executed at the processing unit.

7. The method of claim 1, further comprising:
retrieving the descriptor from memory based on a prefetch instruction including a pointer to the descriptor, wherein the prefetch instruction indicates a size of the descriptor based on a number of dimensions associated with the memory access pattern.

8. The method of claim 1, wherein the descriptor indicates N dimensions of the memory access pattern, wherein N is an integer greater than two.

9. The method of claim 1, wherein the descriptor indicates a plurality of loop sizes for N different dimensions of memory access, and wherein at least one of the plurality of loop sizes is based on a corresponding stride length indicated by the descriptor.

10. The method of claim 1, further comprising:
adjusting a rate of issuance of subsequent prefetch requests at the hardware prefetcher based on measuring a timeliness of the plurality of prefetch requests relative to a corresponding plurality of demand requests at the processing unit.

11. A processing unit, comprising:
a cache;
a hardware prefetcher configured to generate a plurality of prefetch requests based on a descriptor indicating a memory access pattern; and
wherein the cache is configured to prefetch data based on the plurality of prefetch requests.

12. The processing unit of claim 11, wherein the descriptor indicates a plurality of loop sizes for N different dimensions of memory access, where N is an integer greater than one.

13. The processing unit of claim 11, wherein the descriptor indicates a plurality of stride lengths for N different dimensions of memory access, where N is an integer greater than one.

14. The processing unit of claim 11, wherein the descriptor indicates a last address to be prefetched to the cache for the memory access pattern.

15. The processing unit of claim 11, wherein the descriptor indicates a pooling factor for a machine learning model to be executed at the processing unit.

16. The processing unit of claim 11, wherein the descriptor indicates an embedding dimension for a machine learning model to be executed at the processing unit.

17. The processing unit of claim 11, wherein the hardware prefetcher is configured to:
retrieve the descriptor from memory based on a prefetch instruction including a pointer to the descriptor, wherein the prefetch instruction indicates a size of the descriptor based on a number of dimensions associated with the memory access pattern.

18. The processing unit of claim 11, wherein the descriptor indicates N dimensions of the memory access pattern, wherein N is an integer greater than two.

19. The processing unit of claim 18, wherein the descriptor indicates a first loop size for a first dimension of memory access and indicates a first stride length for a second dimension of memory access, and wherein the first loop size is based on the first stride length.

20. A processing system comprising:
a memory; and
a processing unit comprising:
a cache;
a hardware prefetcher configured to generate a plurality of prefetch requests based on a descriptor indicating a memory access pattern; and
wherein the cache is configured to prefetch data based on the plurality of prefetch requests.
